(19) United States
(12) Patent Application Publication
(10) Pub. No.: US 2015/0001267 A1
(43) Pub. Date: Jan. 1, 2015

(54) CARRIER ATTACHMENT FOR A VEHICLE

(71) Applicant: Burro Creative Solutions, Alexandria, VA (US)

(72) Inventor: Robert Ladd Thorsen, Warrenton, VA (US)

(73) Assignee: Burro Creative Solutions, Alexandria, VA (US)

(21) Appl. No.: 14/315,491

(22) Filed: Jun. 26, 2014

Related U.S. Application Data
(60) Provisional application No. 61/839,684, filed on Jun. 26, 2013.

(51) Int. Cl. B62B 5/00

(52) U.S. Cl. CPC B62B 5/0003
USPC 224/401

(57) ABSTRACT

According to at least one exemplary embodiment, a carrier may be overlaid onto a vehicle. The vehicle may be a handle-propelled vehicle, for example a wheelbarrow. The carrier may have contours that fit over the top of the vehicle such that the carrier stays in place relative to the vehicle without additional fastening means when the vehicle is propelled in motion. The carrier design may also allow the carrier to be easily installed and removed from the vehicle. Additionally, the carrier may have a plurality of compartments of varying sizes and shapes. The compartments may be specifically designed to hold a variety of items, for example mobile technology devices, food containers, beverage containers, gardening materials and tools, landscaping materials and tools, or construction materials and tools.

### BACKGROUND

Attachments for a handle-propelled vehicle that have sections to hold different tools are known. Some known attachments are coupled exclusively to the handles of the vehicle. These handle attachments provide limited holding sections. Additionally, known handle attachments are fastened to the handles such that installing and removing an attachment is a tedious, time-consuming task. Further, handle attachments lack capabilities for carrying larger, rod-type tools or objects.

Attachments for a handle-propelled vehicle that attach to a non-handle portion of the vehicle for carrying larger, rod-type tools or objects are known, however they exclusively provide only that single function. Additionally, non-handle attachments are fastened to the vehicle such that installing and removing an attachment is a tedious, time-consuming task or even impossible. Current products are not secure and may be difficult to attach and remove. Additionally, current products do not allow for secure carrying or transport of different sized items.

### SUMMARY

According to at least one exemplary embodiment, a carrier apparatus for a vehicle may be provided. The carrier may be substantially rectangular and may have at least one compartment disposed therein. The carrier may further have at least one hook member disposed therefrom. There may be at least one securing portion disposed on the underside of the carrier, which are configured to receive a rim of a tub, such that carrier 100 can securely rest on the tub.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is a top front perspective view of an exemplary embodiment of a carrier attachment for a vehicle with environment.

FIG. 2 is a top rear perspective view of an exemplary embodiment of a carrier attachment for a vehicle.

FIG. 3 is a top rear perspective view of an exemplary embodiment of a carrier attachment for a vehicle.

FIG. 4 is a bottom perspective view of an exemplary embodiment of a carrier attachment for a vehicle.

FIG. 5 is a rear cross-sectional view of an exemplary embodiment of a carrier attachment for a vehicle.

FIG. 6 is a left side cross-sectional view of an exemplary embodiment of a carrier attachment for a vehicle.

FIG. 7 is a top plan view of an alternative exemplary embodiment of a carrier attachment for a vehicle.

FIG. 8 is a cross-sectional cut-away view showing an alternative exemplary small cylindrical compartment of an exemplary carrier attachment with and without an object disposed therein.

FIG. 9 is a cut-away plan view showing two stacked alternative exemplary embodiments of carrier attachments for a vehicle.

FIG. 10 is a top rear perspective view showing an alternative exemplary embodiment of a carrier attachment for a vehicle.

FIG. 11 is a bottom rear perspective view showing an alternative exemplary embodiment of a carrier attachment for a vehicle.

FIG. 12 is a top plan view showing an alternative exemplary embodiment of a carrier attachment for a vehicle.

FIG. 13 is a bottom plan view showing an alternative exemplary embodiment of a carrier attachment for a vehicle.

FIG. 14 is a left side elevation view showing an alternative exemplary embodiment of a carrier attachment for a vehicle.

FIG. 15 is a right side elevation view showing an alternative exemplary embodiment of a carrier attachment for a vehicle.

FIG. 16 is a rear view elevation view showing an alternative exemplary embodiment of a carrier attachment for a vehicle.

FIG. 17 is a front elevation view showing an alternative exemplary embodiment of a carrier attachment for a vehicle.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

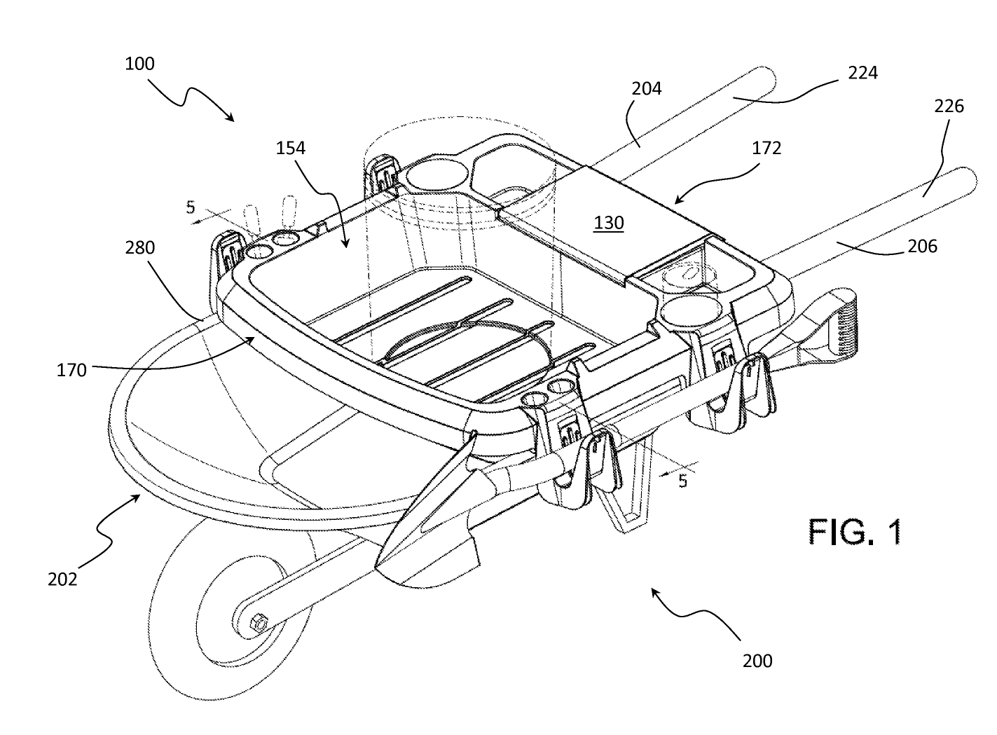

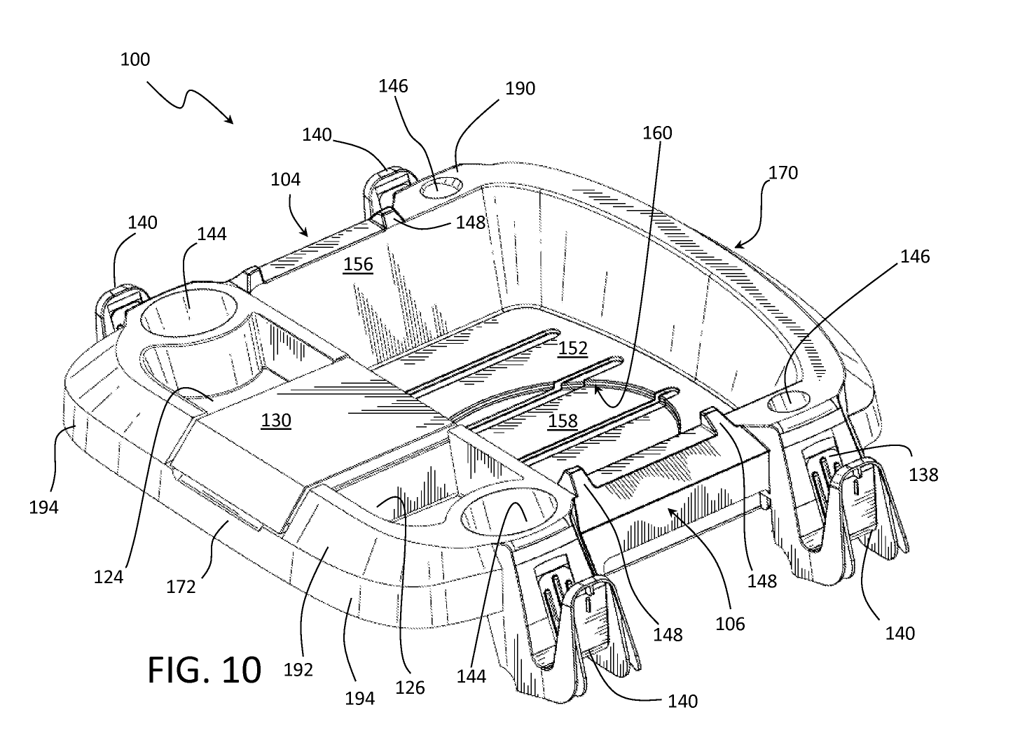

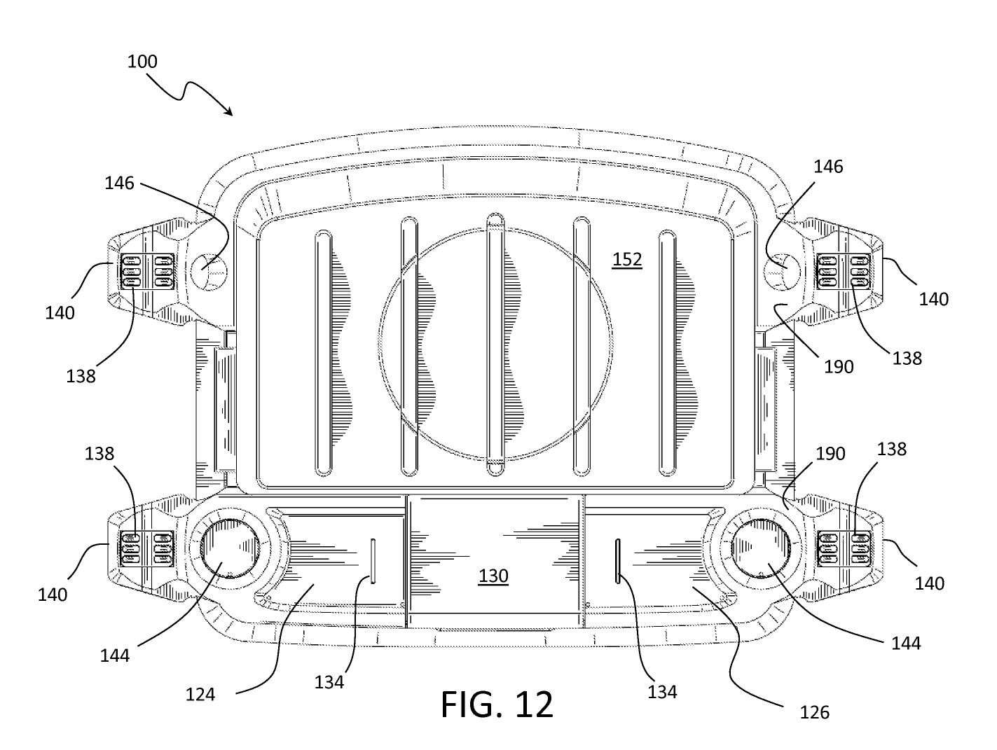

According to some exemplary embodiments, and generally exemplary FIG. 1, a carrier 100 may be freely or securedly attached to a vehicle 200. The carrier 100 may have any number of compartments and securing members of varying sizes and shapes. The compartments may carry or hold a variety of items, including: mobile technology devices, such as cellular phones, smartphones, and tablet computers; everyday items, such as keys, key chains, and wallets; beverage containers, such as bottles and cans; food containers, such as lidded containers and plastic bags; raw gardening materials and bags or containers thereof, such as seeds, plants, fertilizers, and pesticides; landscaping materials and bags or containers thereof, such as stones, rocks, cement, sand, and soil; raw construction materials and bags or containers thereof, such as nails, screws, wire, wood, paint, and metal; and tools for gardening, landscaping or construction, such as hoes, spades, shovels, scoops, forks, rakes, claws hammers, drills, drivers, saws, axes, knives, shears, pruners, cutters, flashlights, brooms, mops, levels, measuring sticks, and measuring tapes. Carrier 100 may be made of a variety of materials including plastic, metal, rubber, wood, or other polymers. Carrier 100 may have a smooth surface or a substantially grainy surface. In an exemplary embodiment, as shown in FIGS. 1-2, 7, 10, and 12, at least one of the compartments may have a lid for closing the compartment. In some embodiments, the lid may substantially prevent the contents of the sealed compartment from interacting with an external environment.

In some exemplary embodiments, and as shown in exemplary FIG. 1, the vehicle 200 may be a hand-propelled vehicle 200, such as a wheel barrow. The vehicle 200 may include a tub 202 and at least one handle member. In some embodiments, there may be a first handle 204 and a second handle 206. Alternatively, there may be a single handle member formed by a cross-member joining the ends of first handle 204 and second handle 206. In some embodiments, tub 202 may be fixed atop first handle 204 and second handle 206, which may extend such that a first grip portion 224 and second grip portion 226 protrude past the rear of tub 202. Handles 204, 206 may also extend past affixed base of tub 202, such that a wheel may be attached proximate a front end of handles 204, 206. There may also be a stand assembly affixed below a rear portion of tub 202, such that the vehicle may rest on the wheel and stand assembly. In some exemplary embodiments, the handles 204, 206, wheel, and stand assembly may be separately affixed to tub 202.

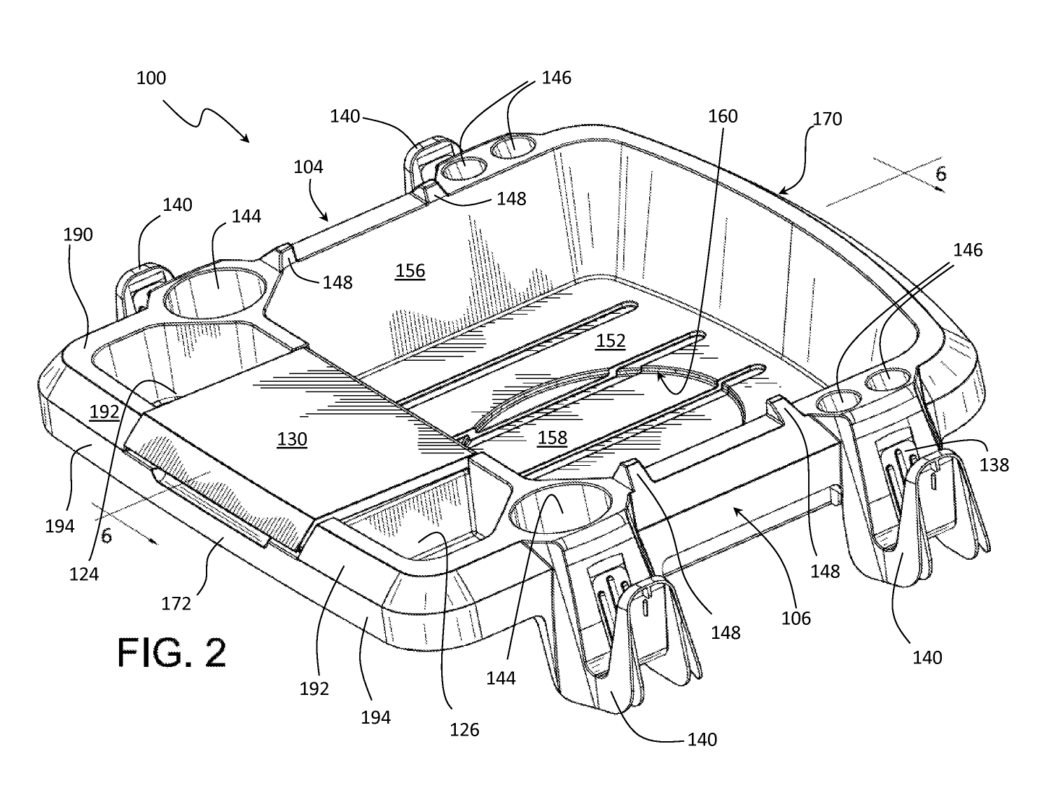

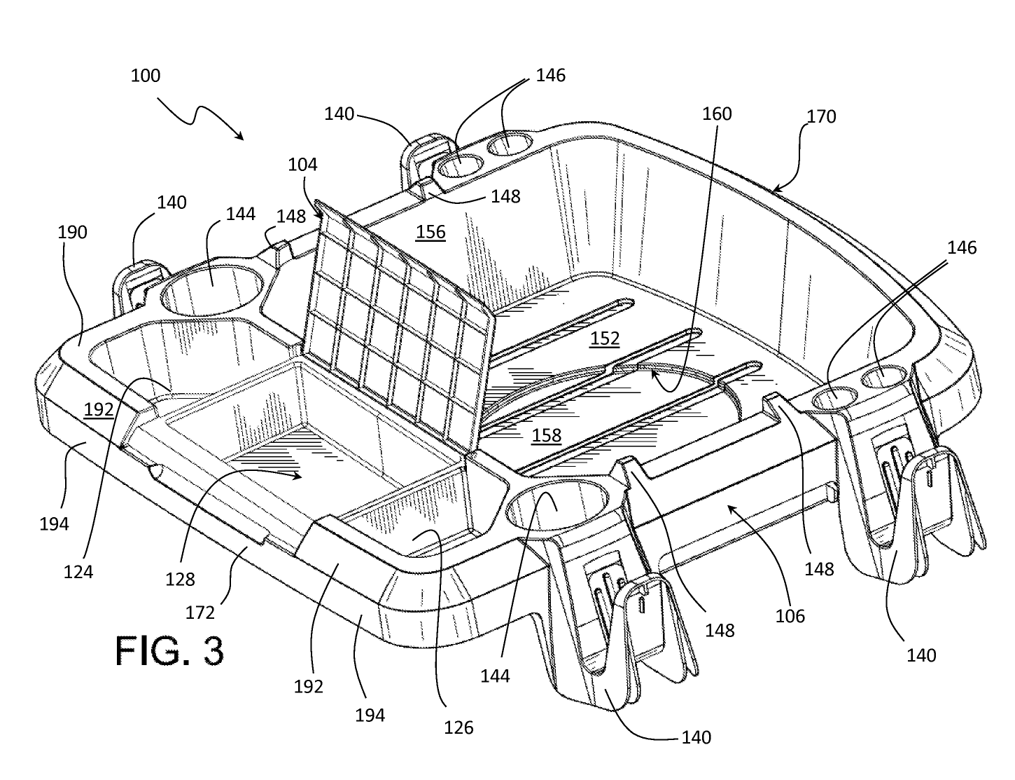

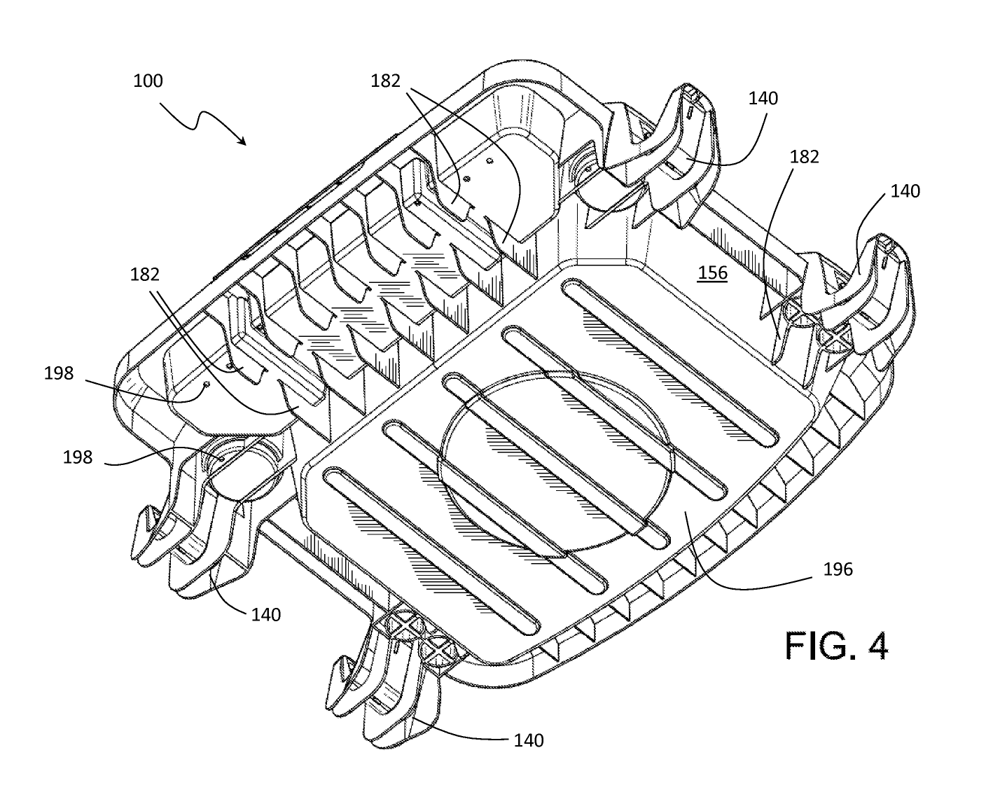

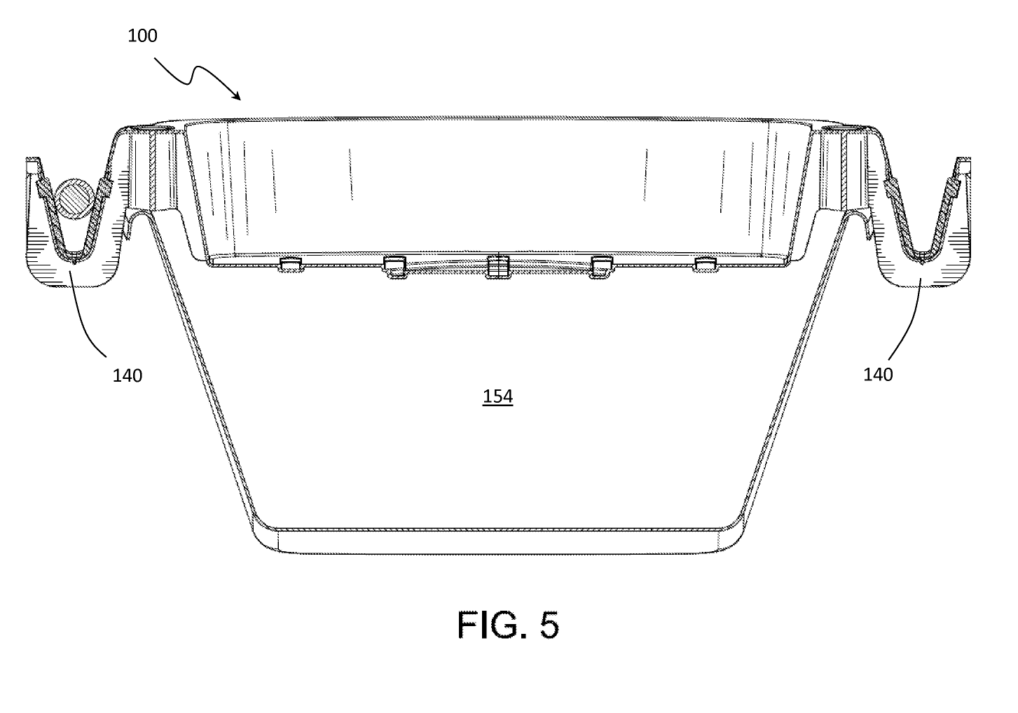

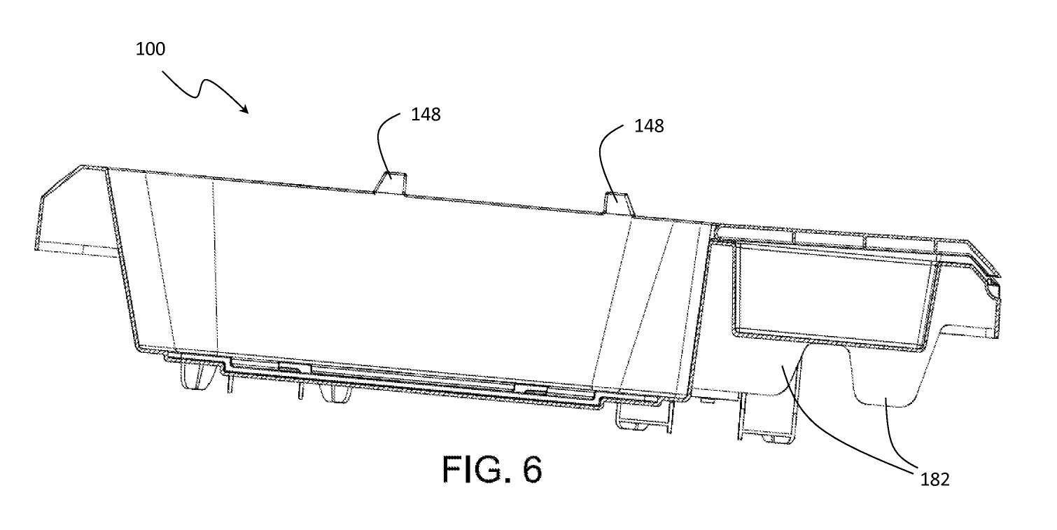

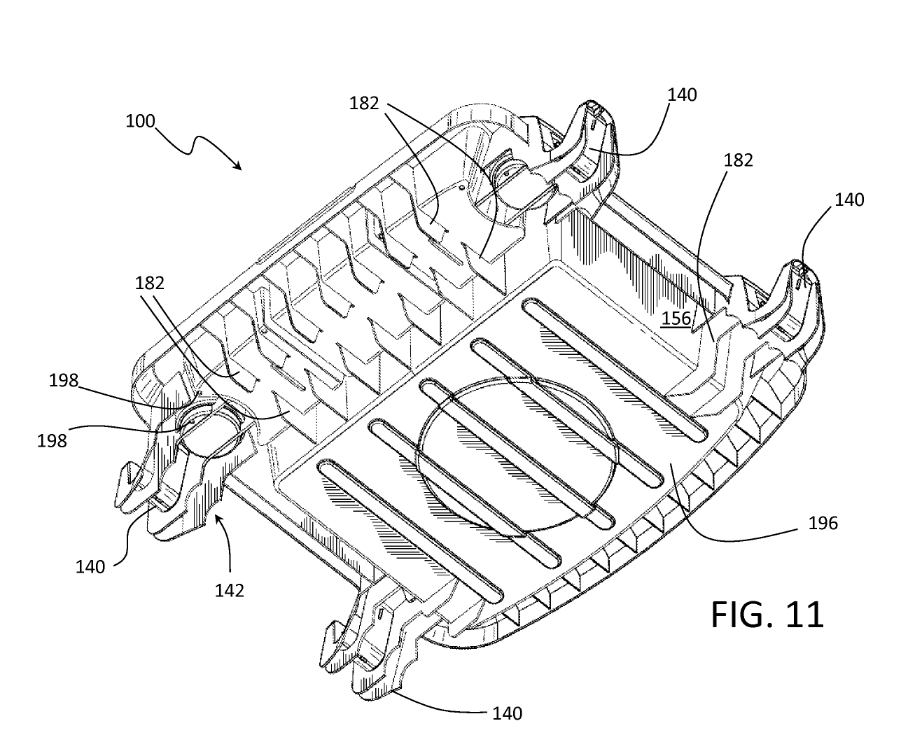

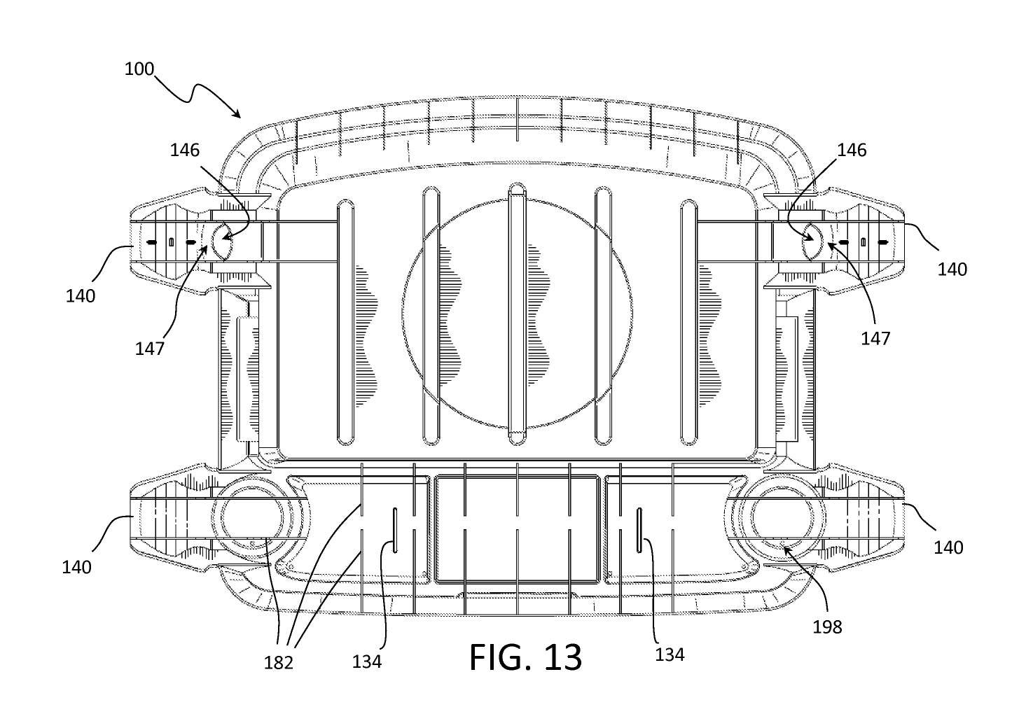

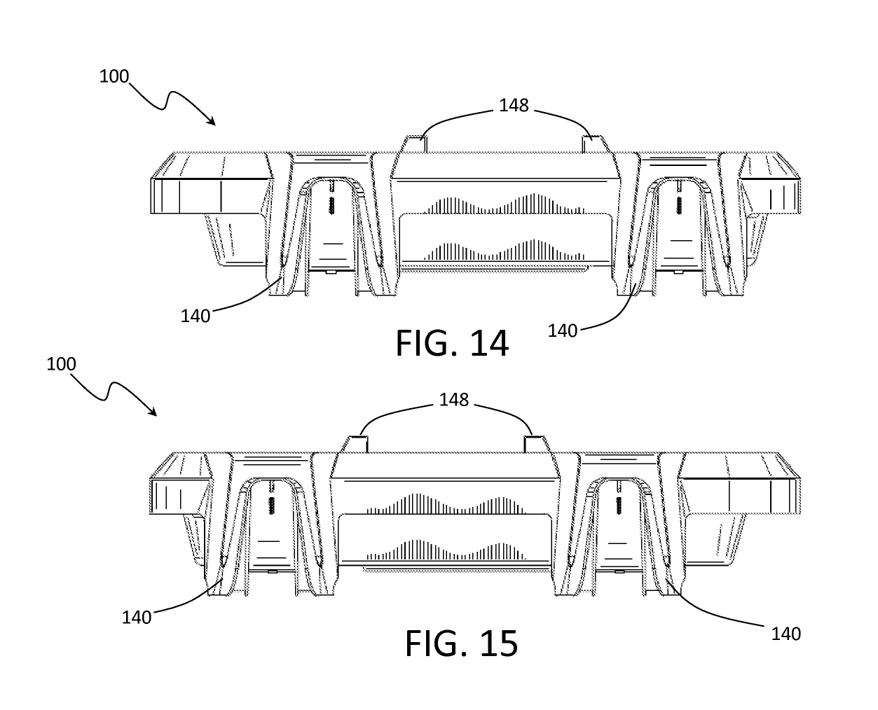

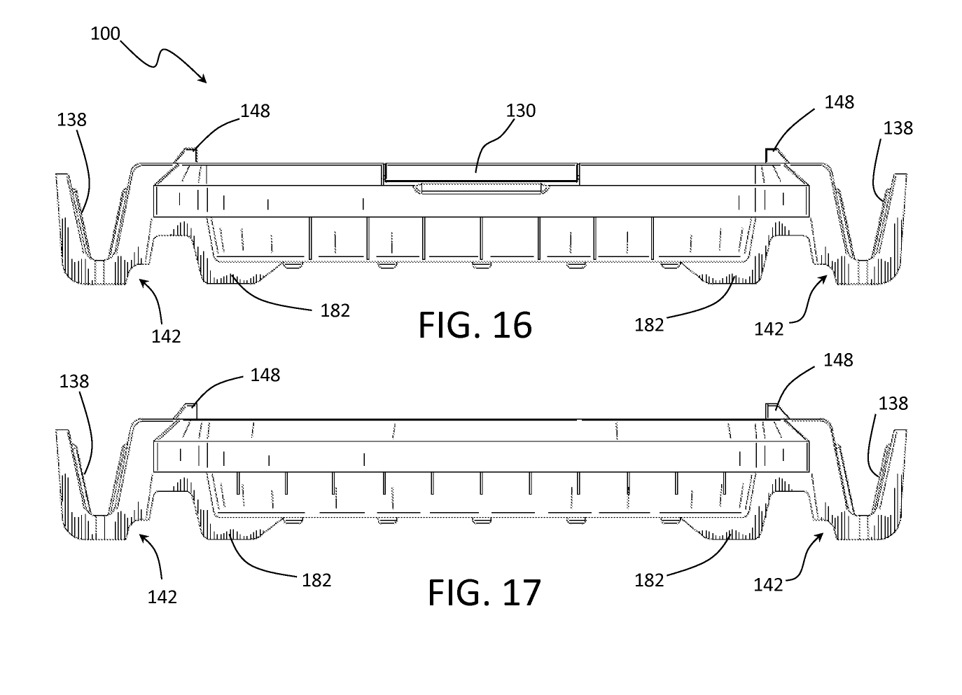

Now referring to exemplary FIGS. 1 through 17, carrier 100 may fit over the top of at least a portion of tub 202 or handles 204, 206. In an exemplary embodiment, carrier 100 may fit over a portion of both tub 202 and handles 204, 206. Carrier 100 may have a top surface 190 and an outer side surface 194 with a top beveled edge 192, as shown in FIGS. 2 and 3. Carrier 100 may have a right side 104, a left side 106, a front side 170, a rear side 172, and an underside 196. Carrier 100 may be substantially rectangular. In some embodiments, carrier 100 may have rounded corners and an outwardly curving front side 170. Carrier 100 may be configured substantially like a carrying tray and may include at least one carrying compartment or attachment member. In an exemplary embodiment, there may be a plurality of carrying compartments and attachment members. At least one of the carrying compartments may be substantially well-like. The compartments may have varying depths. Carrier 100 may be disposed such that it extends over the width of tub 202. Carrier 100 may be affixed to vehicle 200 by resting on at least one of a rim 280 of tub 202 or handles 204, 206. In an exemplary embodiment, carrier 100 may rest on a rear portion and side portions of rim 280. Carrier 100 may rest freely in place or may be secured in place through snap fitting, friction fitting, fasteners, bolts, screws, adhesive, and other securing capabilities as would be understood by a person having ordinary skill in the art. Referring to exemplary FIGS. 4 and 11, there may be securing portions 182 disposed on the underside 196 of carrier 100. The securing portions may be configured to receive a rim 280 of tub 202. In an exemplary embodiment, securing portions 182 may be disposed along perimeter side edges of carrier 100. Securing portions 182 may additionally be disposed to cross laterally below carrier 100 to receive a rear portion of rim 280. The lateral securing portions may be disposed between a rear wall of a main compartment 154 and a rear edge of carrier 100. The location of securing portions 182 may vary depending on the desired orientation of carrier 100. Exemplary securing portions 182 may include rib-like flanges configured to form a receiving track for the rim of tub 202. Securing portions 182 may be tapered or shaped to facilitate positioning on and receiving a rim 280. Rim 280 may fit freely within the receiving track or may be secured in the track through snap fitting, friction fitting, or other known securing configurations as would be reasonably understood by a person having ordinary skill in the art. In some embodiments, securing portions 182 on the right side 104 and left side 106 may include the wall of the compartments and the shanks of the hook members.

Referring to exemplary FIGS. 1, 4, 11, and 13 the alignment of the securing portions 182 may allow the carrier 100 to fit over the top of the vehicle 200 such that the carrier 100 may remain in place relative to the vehicle 200 without additional fastening capabilities when the vehicle 200 is propelled in motion. This design may also allow the carrier 100 to be easily installed and removed from the vehicle 100. In some exemplary embodiments, to provide extra coupling security, the carrier 100 may be coupled to the vehicle 200 via any known fastening capabilities, for example clips, hooks, loops, hoops, screws, nuts and bolts, or adhesives.

Referring to exemplary FIGS. 1-17 generally, carrier 100 may have at least one compartment configured for holding or securing objects to vehicle 200. In an exemplary embodiment, there may be a large, well-like main compartment 154 disposed substantially over tub 202. Main compartment 154 may stretch substantially the width of tub 202. In some embodiments, the depth of main compartment 154 may extend down into tub 202. Alternatively, carrier 100 may be configured such that the depth of main compartment 154 can be disposed completely above basin of tub 202. In an exemplary embodiment, main compartment 154 may be substantially rectangular. Main compartment 154 may have sidewalls 156 and a bottom surface 152. The sidewalls 156 of main compartment 154 may be substantially vertical or may be tapered, such that main compartment's 154 bottom surface 152 has a smaller area than the area of main compartment's 154 opening in a top surface 190 of carrier 100. Main compartment 154 may have a smooth or ridged bottom surface 152. In some exemplary embodiments, main compartment 154 may have a recess 158 disposed in its bottom surface, configured for receiving an object, such as a bucket. The recess 158 may have a perimeter shaped substantially similar to the perimeter of the base of the object it is intended to receive. The lip 160 of the recess may retain the object within the recess. Additionally, main compartment 154 may have at least one aperture disposed in bottom surface 152 or sidewalls 156. In some exemplary embodiments, a front side 170 of carrier 100 may be slightly curved. Additionally, at least one corner of main compartment 154 may be beveled.

Still referring to exemplary FIGS. 1-17 generally, some exemplary embodiments may have a plurality of compartments. These compartments may include at least one rear compartment, located proximate a user of grip portions 224, 226. In one exemplary embodiment, there may be three rear compartments: left rear compartment 124, right rear compartment 126, and center rear compartment 128. The rear compartments may, in series, span approximately the width of main compartment 154. The depth of the rear compartments may be shallower than main compartment 154. The shallower depth may allow the rear compartments to be oriented above a rear portion of rim 280. At least one of the plurality of compartments in carrier 100 may have a lid portion. The lid portion may be hingedly attached, such that it may be opened to gain access to a compartment. Alternatively, the lid portion may be configured to attach by snap fitting or friction fitting, such that the entirety of the lid portion may be removed for access to a compartment. In an exemplary embodiment, compartment 128 may have a lid portion 130. Lid portion 130 may be hingedly connected, such that it opens toward grip portions 224, 226 of handle members 204, 206. This may allow a user to access compartment 128 while operating vehicle 200. In such an embodiment, compartment 128 and lid portion 130 may be substantially rectangular. Right rear compartment 124 and left rear compartment 126 may also be substantially rectangular. Similar to main compartment 154 the rear compartments may have sloped walls, tapering the compartments so that their bottom surface is smaller than the opening in top surface 190 of carrier 100.

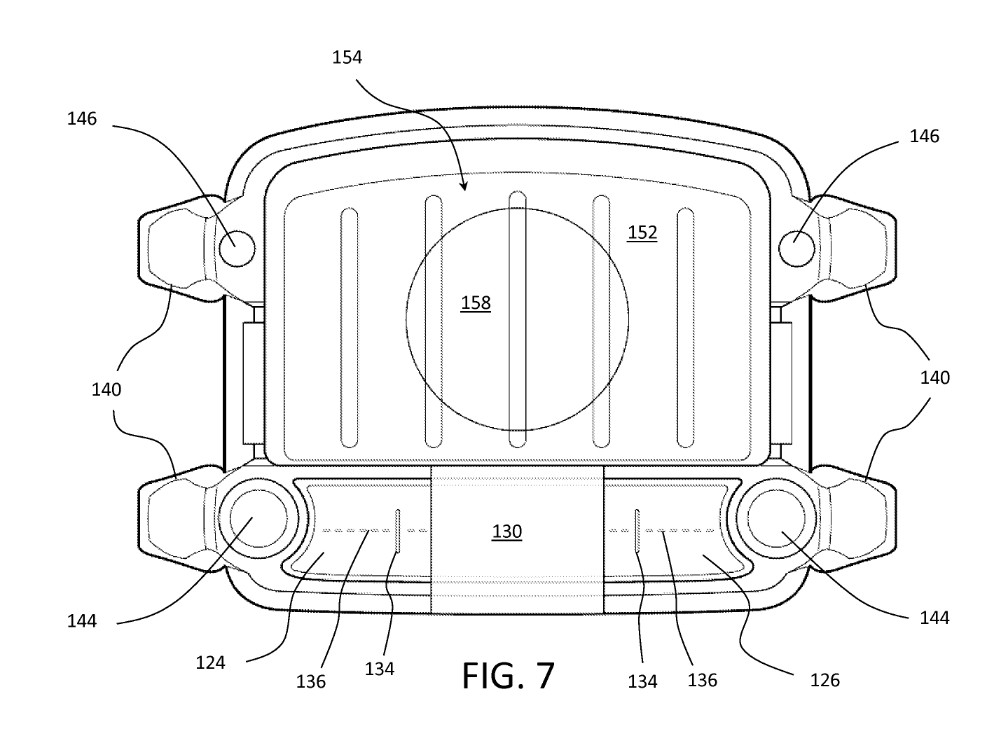

As shown in exemplary FIG. 7, there may be apertures 134 disposed through carrier 100 to facilitate aligning carrier 100 when placing it on a vehicle. Additionally, a visual indicator 136 with which to align rim 280 may be disposed proximate apertures 134. In some embodiments, the visual indicator 136 may include a raised, dashed line.

In an exemplary embodiment, there may be at least one hook member 140 disposed on carrier 100. In some embodiments, there may be two hook members 140 disposed on the right side 104 of carrier 100 and two hook members 140 disposed on the left side 106 of carrier 100. One hook member 140 on right side 104 and one hook member 140 on left side 106 of carrier 100 may be disposed proximate a front side 170 of carrier 100. One hook member 140 on the right and left side 104, 106 may be disposed proximate a rear side 172 of carrier 100. The rear hook members 140 may be disposed proximate a portion of top surface 190 that divides main compartments 154 from the at least one rear compartment. Hook members 140 may extend down and outward from carrier 100. Hook members 140 may be configured to hold elongated objects, such as poles or long handled tools, such as shoves, brooms, rakes, axes, etc. The gap of the hook may be substantially V-shaped to hold a range of handle sizes or objects. There may additionally be a gripping portion disposed on hook member 140 to securely hold objects. In an exemplary embodiment, the grip portion may be a rubber or elastomeric grip 138 disposed within the gap of hook member 140. In an exemplary embodiment, hook members 140 may be substantially rigid and may have the elastomeric grip 138 applied on the inner face of the V. The elastomeric grip 138 may be molded with ridges designed to conform and deform to an object disposed within the hook, when pressed into the elastomeric material, creating a grip on the object. In some exemplary embodiments, the elastomeric material may be silicone rubber. Hook members 140 may also be used to attach buckets, hanging objects, towels, etc.

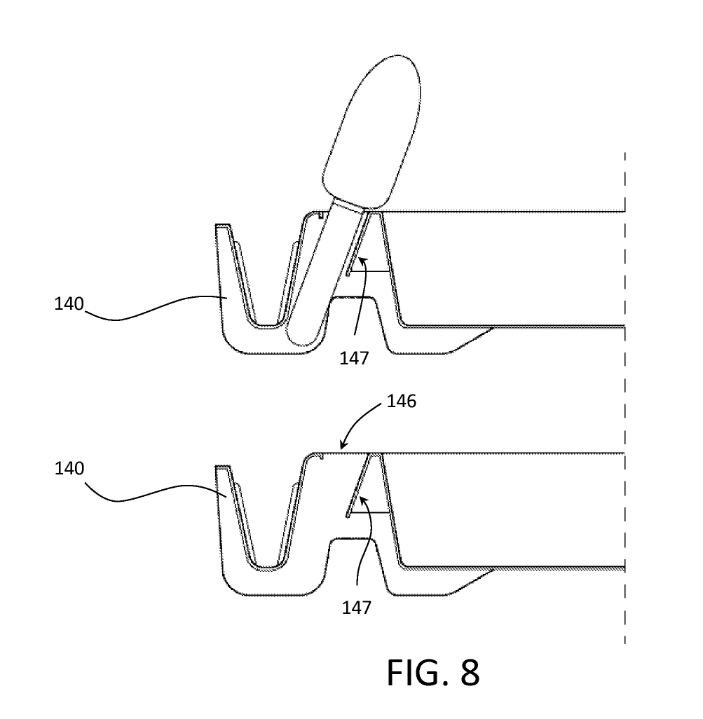

Referring to exemplary FIGS. 1-3, 7, and 12, top surface 190 may extend outward proximate hook members 140. This may allow a shaft of hook members 140 to extend up to top surface 190. It may also provide for the placement of additional compartments. In an exemplary embodiment, there may be at least one small cylindrical compartment 146 disposed in carrier 100. The at least one small cylindrical compartment 146 may be disposed within top surface 190 proximate a hook member 140. In at least one exemplary embodiment, there may be two small cylindrical compartments 146 disposed in top surface 190 proximate a hook member 140. In some embodiments, the compartments proximate hook members 140 may be configured differently. For example a single rectangular compartment could be disposed proximate hook members 140, rather than two cylindrical compartments. There may be a differently configured compartment in top surface 190 proximate each hook member 140. In at least one exemplary embodiment, there may be two cylindrical compartments 146 disposed proximate the hook members 140 near the front side of carrier 100. The small cylindrical compartments 146 may be configured to hold short handled tools. As shown in exemplary FIGS. 7, 10, and 12-13, there may be a single small cylindrical compartment 146 disposed proximate the front hook members 140. The at least one small cylindrical compartment 146 may be disposed at an angle such that an objected within compartment 146 does not interfere with rim 280, as shown in exemplary FIG. 8. In some embodiments, compartment 146 may include only an aperture through carrier 100 and an angled wall 147 to direct an object, such as the handle of a hand tool disposed in compartment 146, away from rim 280. There may be a single larger cylindrical compartment 144 disposed proximate the hook members 140 near the rear side of carrier 100. Corners of main compartment 154 and the at least one rear compartment may be beveled to provide for larger cylindrical compartments 144. Alternatively, in some exemplary embodiments and as shown in FIG. 7, larger cylindrical compartments 144 and hook members 140 may be aligned with rear compartments 124, 126. In an exemplary embodiment, the single larger cylindrical compartment 144 may hold a beverage container.

In an exemplary embodiment, there may also be board securing members 148 protruding from the top surface 190 of carrier 100. There may be four board securing members 148 configured to secure at least one board such that it rests laterally on top of carrier 100. Board securing members 148 may be upward protrusions from top surface 190. There may be at least two board securing members 148 on a right side 104 of carrier 100 and at least two board securing members 148 on a left side 106 of carrier 100. In an exemplary embodiment, the board securing members may be configured to receive an about 6 x 6 board, or a board of any other size. Board securing members 148 may be aligned such that the securing members 148 on opposite sides of carrier 100 form a single track that may allow a board to rest laterally on carrier 100. For example, a 6×6 may be disposed such that it is received between board securing members 148 on the right side 104 of carrier 100 and between board securing members 148 on the left side 106 of carrier 100. Board securing members 148 may create a receiving track for a board to assist in keeping the board in a desired orientation when it is inserted in the track. In some exemplary embodiments, board securing members 148 may be adjustable, so as to fit a desired board size.

As shown in exemplary FIG. 4, carrier 100 may have a plurality of apertures 198 disposed through its bottom surface, within the plurality of compartments. These apertures 198 may facilitate drainage. Additionally, all of the compartments may be subdivided by vertical or horizontal dividing members. The walls of the various compartments may be sloped so as to facilitate settling objects toward a bottom surface of the compartments. Furthermore, a front lid may be coupled to the front side 170 of carrier 100. The front lid may fit over the exposed portion of the tub 202 that is not already covered by the carrier 100.

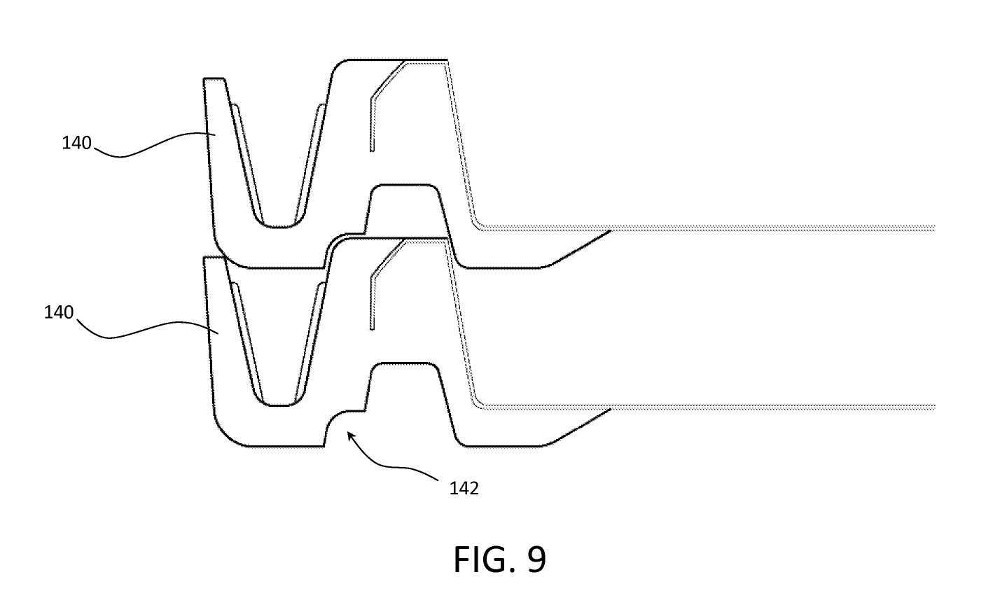

As shown in exemplary FIG. 9, hook members 140 and securing portions 182 may have cut-outs or notches 142 to facilitate stacking and storage of vehicle carriers 100.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A carrier attachment apparatus for a vehicle comprising:
a substantially rectangular carrier portion;
at least one compartment disposed in the substantially rectangular carrier portion;
at least one hook member disposed on a side of the carrier; and
at least one securing portion disposed on an underside of the carrier and configured to receive a rim of a tub, such that the carrier can securely rest on the tub.

2. The carrier of claim 1, wherein the at least one hook member has an elastomeric grip disposed thereon.

3. The carrier of claim 1, further comprising a plurality of board securing members protruding from a top surface of the carrier.

4. The carrier of claim 1, wherein the at least one compartment includes a main well-like compartment.

5. The carrier of claim 4, wherein the main well-like compartment has a recess disposed in its bottom surface for receiving and securing an object.

6. The carrier of claim 4, further comprising at least one rear well-like compartment, at least one large cylindrical compartment, and at least one small cylindrical compartment.

7. The carrier of claim 1, further comprising at least one lid portion configured to cover at least one of the at least one compartment.

8. The carrier of claim 1, further comprising at least one aperture in the bottom or side wall of at least one of the at least one compartment, configured to facilitate drainage.

9. The carrier of claim 1, wherein the at least one securing portion is a series of rib-like flanges configured to form a track for receiving the rim of the tub.
